(19) United States
(12) Patent Application Publication
(10) Pub. No.: US 2013/0319223 A1
(43) Pub. Date: Dec. 5, 2013

(54) OPTICAL SENSOR ENCLOSURE WITH INTEGRAL WINDOW AND OPTICAL ALIGNMENT FEATURES

(71) Applicants: Dave Bina, Northfield Center, OH (US); James Cirillo, Cleveland Heights, OH (US)

(72) Inventors: Dave Bina, Northfield Center, OH (US); James Cirillo, Cleveland Heights, OH (US)

(21) Appl. No.: 14/000,132

(22) PCT Filed: Feb. 21, 2012
(86) PCT No.: PCT/US12/25876

§ 371 Date: Aug. 16, 2013

Related U.S. Application Data
(60) Provisional application No. 61/444,443, filed on Feb. 18, 2011.

(51) Int. Cl. G01B 11/14

(52) U.S. Cl. CPC G01B 11/14
USPC 92/5 R; 356/614; 29/428

(57) ABSTRACT

An enclosure for a position sensor includes a housing and a lower Cassette that cooperate to provide a sealed volume in which a sensor assembly is enclosed and protected. The sensor assembly includes a light source and a light detector. The sensor assembly further includes a light pipe that guides light from the light source onto a target and a lens that guides reflected light from the target onto the light detector. The lower cassette is transparent to the light produced by the light source and includes an integral window through which the light enters and exits the lower cassette. An upper cassette supports an upper portion of the light pipe and the lens. A recess adjacent the window supports a lower portion of the light pipe and the lens in the lower cassette, and the upper cassette is received in a receptacle formed inside the lower cassette.

### RELATED APPLICATIONS

This application claims the benefit of U.S. Provisional Application No. 61/444,443 filed Feb. 18, 2011, which is hereby incorporated herein by reference.

### FIELD OF THE INVENTION

The present invention relates to a piston-cylinder assembly having a sensor for detecting the position of a piston rod relative to a cylinder housing, and more particularly to an enclosure for sensor components that maintains proper location and alignment of an optical train for application in absolute position sensing.

### BACKGROUND OF THE INVENTION

Piston-cylinder assemblies are used in various actuator applications throughout industry, such as in construction equipment. Often it is advantageous for an operator to be aware of the specific position of a piston rod in a fluid pressure-operated cylinder since the working member being actuated is generally physically connected to the end of the piston rod.

U.S. Pat. No. 7,047,865, for example, discloses a known actuator with a cylinder housing and a rod that is axially movable relative to the cylinder housing. The actuator also has sensor for absolute position sensing in which light from a light source illuminates a pattern on the rod. The sensor is attached to the cylinder housing and detects light reflected from an adjacent portion of the pattern. The position of the rod relative to the housing is determined from the known position of the sensor relative to the housing and the portion of the pattern detected by the sensor.

In contrast to absolute-position sensors, relative-position sensor systems also are known, but they require periodic “zeroing” to maintain accurate position information. In the event of a power failure, for example, the rod generally must be retracted to a “home” position before being extended again. Depending on the circumstances when the hydraulic cylinder lost power, this might not be practical or even possible. An absolute position sensor always knows the position of the rod, even after a power failure. Knowing absolute position also can be used to more accurately control the actuator extension/retraction.

### SUMMARY OF THE INVENTION

The present invention provides an improved enclosure for a position sensor. The enclosure includes a housing and a lower cassette that cooperate to provide a sealed volume in which an optical sensor assembly is enclosed and protected. The optical sensor assembly includes a circuit board mounted in the housing. The circuit board includes a light source and a light detector. The sensor assembly further includes optical elements that guide light from the light source onto a target and reflected light from the target onto the light detector. The lower cassette is transparent to the light produced by the light source and forms a window through which the light enters and exits the lower cassette. The window is thus an integral part of the structural enclosure, specifically the lower cassette, and is not a separate element. The lower cassette is a single piece, and preferably is molded of a transparent material, such as plastic. Care must be taken when molding the lower cassette that the liquid material injected into the mold does not form a front that stops where it would extend across the window, or other distortion-creating artifacts of the molding process.

The present invention thus provides an optical sensor with a novel integration of an optical window with a structural lower cassette portion of an enclosure that protects a sensor assembly while allowing light to pass through, facilitating the provision of uniform illumination on a target and the reception of reflected light from the target.

More particularly, the present invention provides [paraphrased claims to be inserted]

Further features of the invention will become apparent from the following detailed description when considered in conjunction with the drawings.

### BRIEF DESCRIPTION OF THE DRAWINGS

FIG. 1 is perspective view of an exemplary actuator with a sensor.

FIG. 2 is a cross-sectional view of the actuator shown in FIG. 1 as seen along lines 2-2.

FIG. 3 is a perspective view of a window side of the sensor provided by the present invention.

FIG. 4 is a plan view of a housing side of the sensor shown in FIG. 3.

FIG. 5 is a cross-sectional view of the sensor of FIG. 4 as seen along lines 5-5.

FIGS. 6 and 7 are perspective exploded views of the sensor of FIG. 4.

### DETAILED DESCRIPTION

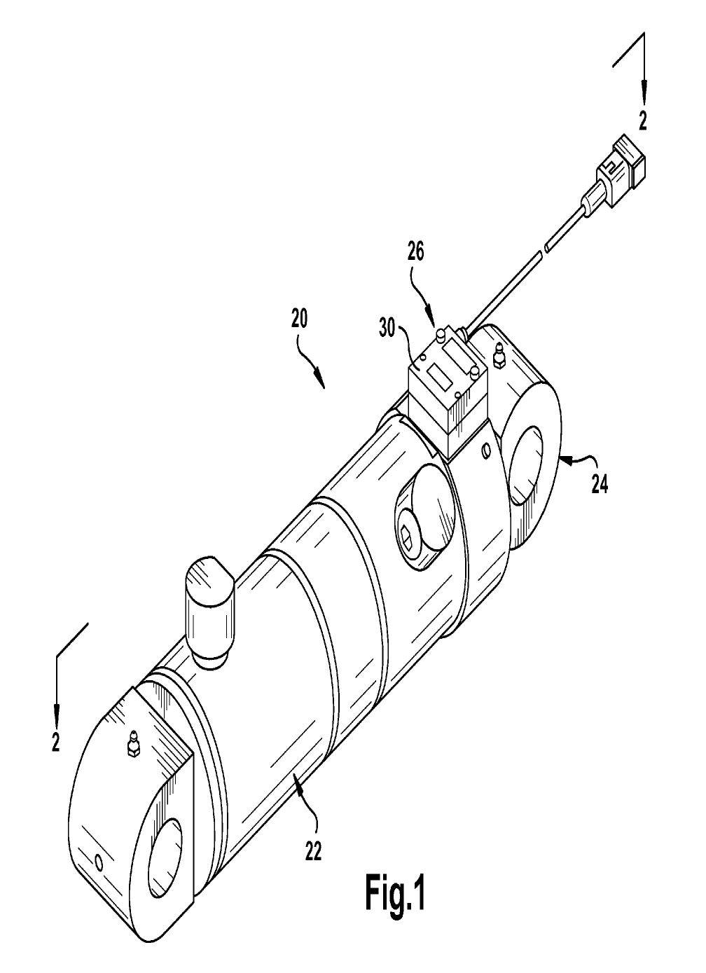

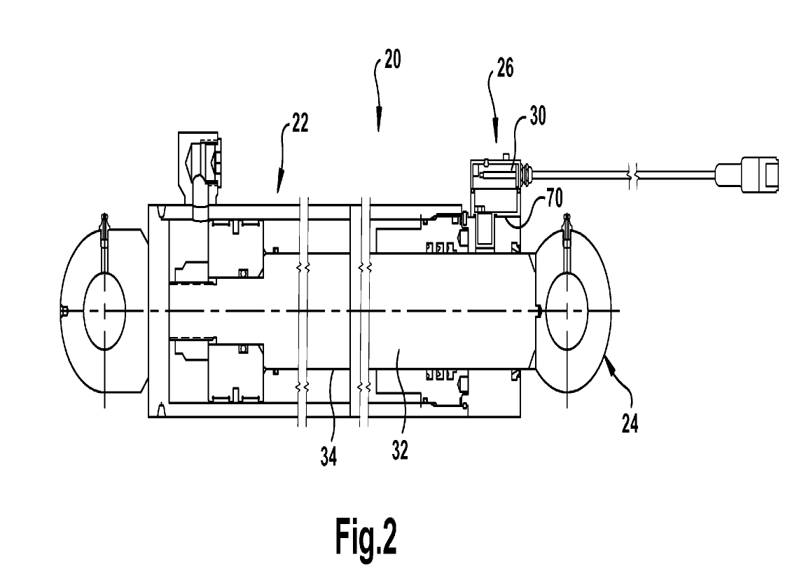

Referring now to the drawings and initially to FIGS. 1 and 2, an exemplary embodiment of an actuator provided by the invention is shown generally at 20. The actuator 20 includes a cylinder assembly 22, a piston assembly 24 that is movable relative to the cylinder assembly 22, and a sensor assembly 26 with a sensor 30 for detecting the position of the piston assembly 24 relative to the cylinder assembly 22. The piston assembly 24 includes an elongated piston rod 32 that has indicia markings (not shown) provided on at least a longitudinal portion of its peripheral surface 34. These markings include patterns that vary along the length of the rod 32, enabling the sensor 30 to identify the position of the rod 32 from a portion of the pattern adjacent the sensor 30.

Although the invention is described with reference to a piston-cylinder actuator 20, the sensor 30 can be used with hydraulic actuators, pneumatic actuators, rotary actuators, or any other device that requires position sensing, either relative or absolute. Additionally, although the indicia were described as markings on the surface of the rod, the markings can be provided below the surface of the rod, and can be printed, etched, cut, embedded, or otherwise formed in or on the rod, so long as the indicia function to identify a position on the rod.

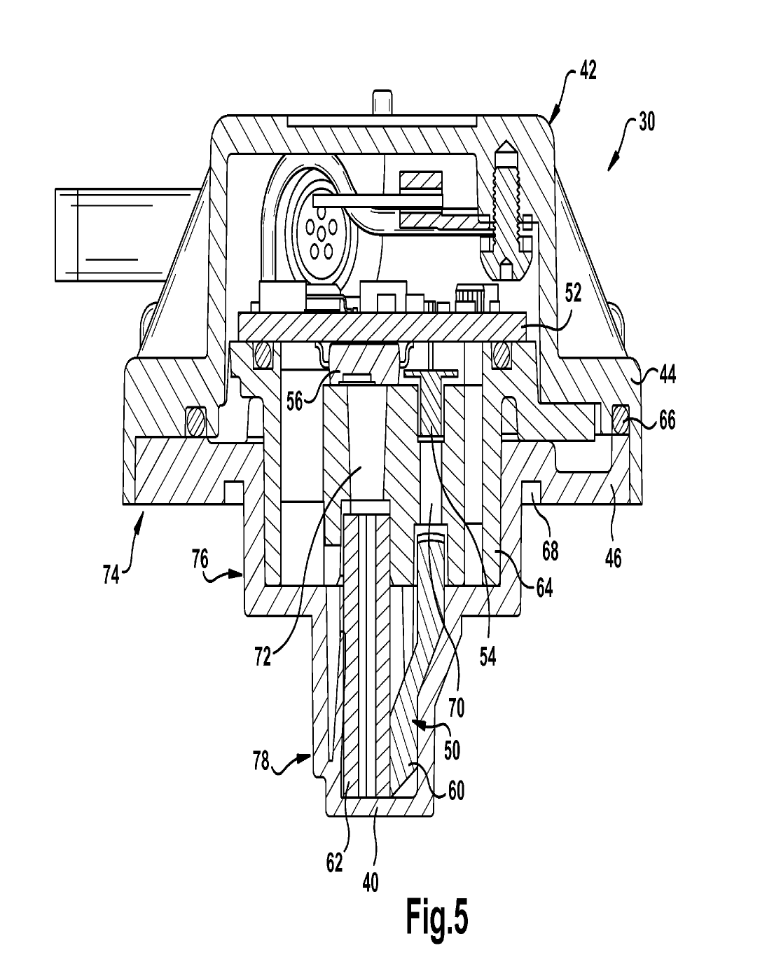

International Patent Application Publication No. WO 2009/140503, published Nov. 19, 2009, discloses an exemplary absolute position sensor, referred to as a probe. The probe has a housing with a lower casing and an upper casing. A cassette supports an optical assembly. A window is integrally formed in or is separate from but supported by the cassette. See FIGS. 5 and 8, for example. In both embodiments the window is recessed and separate from the surface of the housing. The lower casing of the housing thus reduces the field of view through the window and the amount of light that can be received and analyzed by the light detector.

This construction also adds additional components and manufacturing steps. For example, to maintain a proper alignment of the all the optical components, the internal dimensions of the lower casing and external dimensions of the cassette must be controlled to maintain alignment of the optical pathways. If the dimensions are not properly maintained, the optical paths can be compromised and there is a potential to impart stress on the cassette and thereby in the window. Stress on the window would be likely to induce optical distortion in the window.

Unlike such prior art sensors, the present invention provides a sensor 30 with an integral window 40 in the structure of an enclosure 42, rather than recessed within the enclosure 42 or provided separately from the enclosure 42. This simplifies assembly and reduces the number of parts, while also expanding the field of view for the light exiting and entering the sensor 30. The illustrated window 40 is planar, or flat, with a large surface for the transmission of light with minimal and uniform distortion. Alternatively, the window 40 can act as a lens, in which case the window can be curved or have varying thickness or a combination thereof.

Integrating the window 40 into a structural portion of the enclosure 42 is complicated by the need to maintain optical clarity in the window 40. The enclosure 42 includes a housing 44 and a lower cassette 46 that cooperate to enclose the sensor assembly 26. The lower cassette 46 typically is made of a plastic or similar moldable material. The lower cassette 46 can be formed in an injection molding process, for example, but the window 40 must be formed without any optical distortion-creating artifacts of the molding process, such as weld lines, gate marks, or other defects that cause optical distortion, particularly non-uniform distortion while still maintaining structural integrity. For these and other reasons, in prior optical sensors, such as those disclosed in Publication No. WO 2009/140503, the window is a separate component or is provided as a separate component from structural portions of the enclosure.

This construction also reduces the tolerances required to align the optical components, as the outside dimensions of the lower cassette 46 are no longer relevant to maintain optical paths.

The present invention thus provides an optical sensor 30 with a novel integration of an optical window 40 with a structural lower cassette 46 portion of an enclosure 42 that protects the sensor assembly 26 while allowing light to pass through, facilitating the provision of uniform illumination on a target and the reception of reflected light from the target.

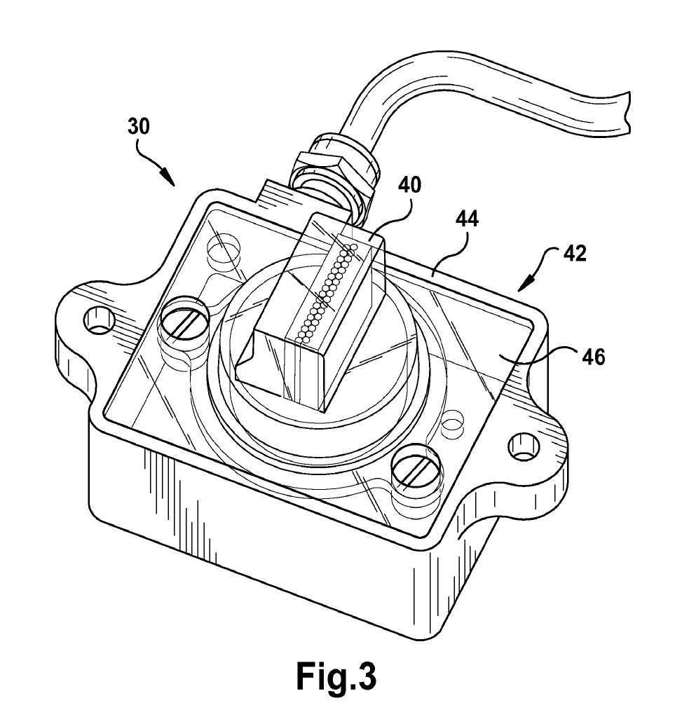

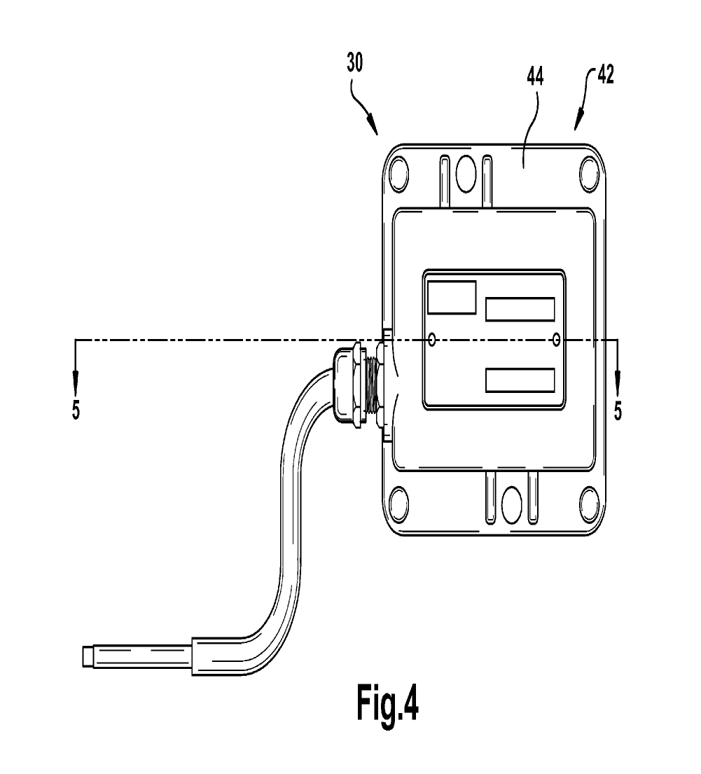

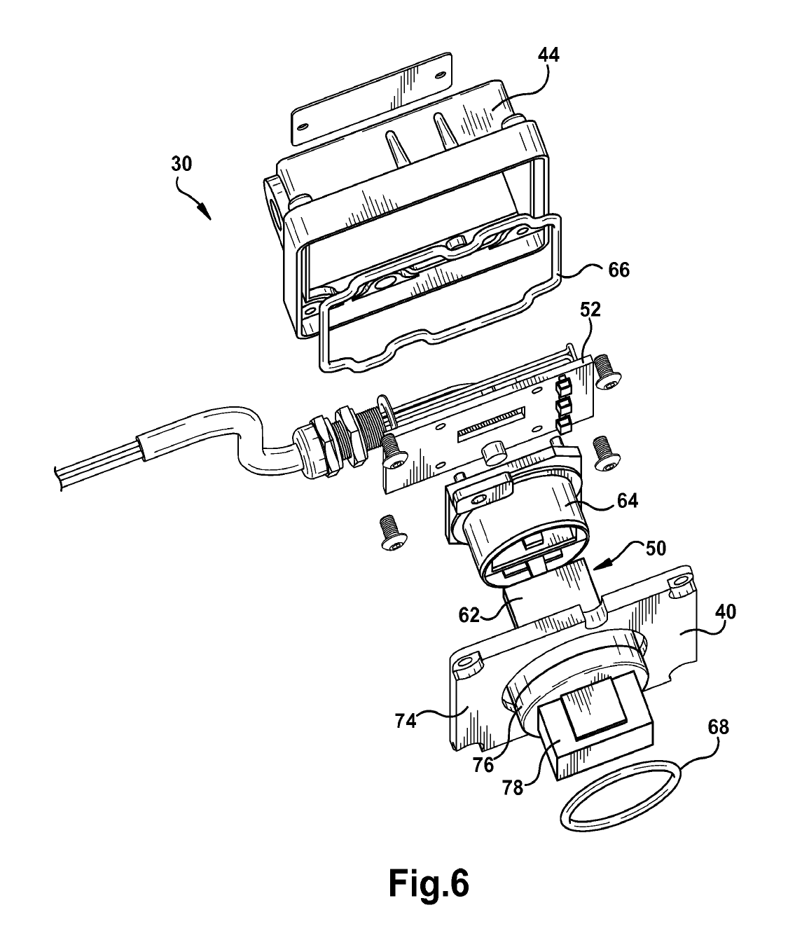

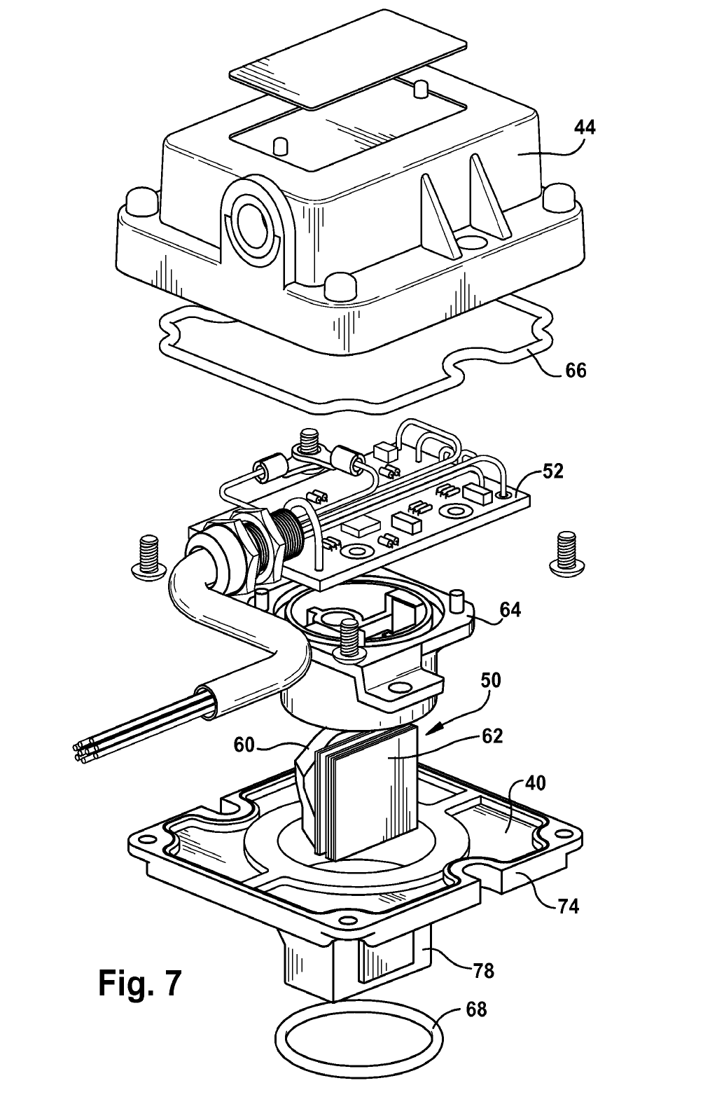

An exemplary sensor 30 provided by the invention is shown in further detail in FIGS. 3-7. The sensor 30 includes the enclosure 42, composed of the housing 44 and the lower cassette 46, and the sensor assembly 26. The sensor assembly 26 includes a light guidance assembly 50, a circuit board 52 with a light source 54, such as a light-emitting diode (LED), and a light detector 56, such as a charge-coupled device (CCD). The light guidance assembly 50 provides means for guiding light from the light source 54 to a target, such as the marked surface 34 of a piston rod 32 (FIG. 2), and for guiding light reflected from the target to the light detector 56. An exemplary light guidance assembly 50 includes a light pipe 60 that guides light from the light source 54, typically infrared (IR) or visible wavelengths, to illuminate the target. An exemplary light guidance assembly 50 also can include a lens, such as a GRIN lens 62, which is formed by an array of glass rods that have a graded index of refraction profile across each individual rod diameter so that the complete array acts like a single lens. The lens 62 is mounted such that it engages the window 40 in the lower cassette 46. When the lens 62 is placed at a proper focal distance from the target and the light detector 56, the lens 62 forms a one-to-one image of an adjacent portion of the target on the light detector 56.

The illustrated sensor 30 also includes an upper cassette 64 interposed between the lower cassette 46 and the circuit board 52 to help to ensure the proper alignment of the optical elements of the guidance assembly 50 relative to the light source 54 and the light detector 56 on the circuit board 52. The sensor 30 also includes a seal 66 between the housing 44 and the lower cassette 46, and a seal 66 between the lower cassette 46 and a mounting surface, such as 70 (FIG. 2), typically coupled to the cylinder assembly 22 in a piston-cylinder actuator 20 (FIG. 2).

The guidance assembly's 50 optical components, in this case the GRIN lens 62 and the light pipe 60 are placed in the lower cassette 46 in optical contact with the window 40. The assembled lower cassette 46 and optical components 60 and 62 are mated with the upper cassette 64, the circuit board 52, and the housing 44 to complete the enclosure of the sensor assembly 26. In the process, the lens 62 and the light pipe 60 are received in cavities in the upper cassette 64. The upper cassette 64 includes a pair of through-holes 70 and 72 that provide optical pathways through the upper cassette 64. When the upper cassette 64 is aligned with the circuit board 52, these through-holes 70 and 72 are aligned with the light source 54 and the light detector 56, respectively.

The illustrated lower cassette 46 includes a peripheral mounting portion 74 that provides a surface for mounting the lower cassette to the housing 44. Protruding from the mounting portion 74 is a cylindrical section 76 that forms an interior receptacle that is dimensioned to receive the upper cassette 64. Thus the inside dimension of the cylindrical section 76 of the lower cassette 46 and the outside dimension of the upper cassette 64 are important for ensuring proper alignment of the optical pathways from the light source 54 to the window 40 and through the window 40 to the light detector 56. The upper cassette 64 is thus located in the enclosure 42 by the lower cassette 46. The recess formed by the extension 78 supports a lower portion of the light pipe 60 and the lens 62 adjacent the window 40, and the upper cassette 64 includes locating features that define through-holes 70 and 72 that support upper portions of the light pipe 60 and the lens 62 relative to the light source 54 and the light detector 56. The light pipe 60 and the GRIN lens 62 are received in an interior recess formed by a further extension 78 protruding from the cylindrical section 76. The distal end of this extension 78 is provided by the window 40. Thus the lower cassette 46 extends away from the housing 44, and the window 40 forms the distal portion of the lower cassette 46 to provide an unobstructed view to the target.

The present invention also provides a method of making an enclosure 42 for an optical sensor 30, includes the steps of molding a lower cassette 46 from a transparent material, the lower cassette 46 having an integral window 40; and connecting the lower cassette 46 to a housing 44 to define the enclosure 42 to enclose a sensor assembly 26 therein, where the window 40 is free of any optical distortion from the molding step.

During assembly, the light pipe 60 and the GRIN lens 62 are placed in the lower cassette 46, the circuit board 52 is mounted to the housing 44, and the upper cassette 64 is mounted to the circuit board 52. Then the lower cassette 46 is mounted to the housing 44, enclosing the upper cassette 64 and the circuit board 52 between the housing 44 and the lower cassette 46 and inserting the light pipe 60 and the lens 62 into the through-holes 70 and 72 in the upper cassette 64, which is received in the cylindrical section 76 of the lower cassette 46.

In summary, the present invention provides an improved enclosure for a position sensor 30 includes a housing 44 and a lower cassette 46 that cooperate to provide a sealed volume in which a sensor assembly 26 is enclosed and protected. The sensor assembly 26 includes a light source 54 and a light detector 56. The sensor assembly 26 further includes a light pipe 60 that guides light from the light source 54 onto a target and a lens 62 that guides reflected light from the target onto the light detector 56. The lower cassette 46 is transparent to the light produced by the light source 54 and includes an integral window 40 through which the light enters and exits the lower cassette 46. An upper cassette 64 supports an upper portion of the light pipe 60 and the lens 62. A recess adjacent the window 40 supports a lower portion of the light pipe 60 and the lens 62 in the lower cassette 46, and the upper cassette 64 is received in a receptacle formed inside the lower cassette 46.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An optical sensor (30), comprising:
a sensor assembly (26) that includes a light source (54), a light detector (56), and a light guidance assembly (50) that includes a light pipe (60) for guiding light from the light source (54) and a lens (62) for guiding light to the light detector (56);
an upper cassette with locating features for supporting upper portions of the light pipe (60) and the lens (62) relative to the light source (54) and the light detector (56), respectively; and
an enclosure (42) having a housing (44) and a lower cassette (46) that cooperate to enclose the sensor assembly (26) and the upper cassette (64),
where the lower cassette (46) includes an interior receptacle for receiving the upper cassette (64), an integral window (40) that is transparent to light from the light source (54), and an interior recess adjacent the window (40) for supporting lower portions of the light pipe (60) and the lens (62) adjacent the window (40).

2. A sensor (30) as set forth in claim 1 or any other claim, where the lower cassette (46) extends away from the housing (44), and the window (40) forms the distal portion of the lower cassette (46).

3. A sensor (30) as set forth in claim 1 or any other claim, where the lower cassette (46) is molded of a material that is transparent to the wavelength of light produced by the light source (54).

4. A sensor (30) as set forth in claim 3 or any other claim, where the lower cassette (46) is molded of plastic and the window (40) is free of any molding features that would create optical distortion.

5. A sensor (30) as set forth in claim 1 or any other claim, where the light source (54) includes a light emitting diode (LED).

6. A sensor (30) as set forth in claim 1 or any other claim, where the light detector (56) includes a charge coupled device (CCD).

7. A sensor (30) as set forth in claim 1 or any other claim, where the lens includes a gradient-index (GRIN) lens (62).

8. A sensor (30) as set forth in claim 1 or any other claim, where the sensor assembly (26) includes a circuit board (52), the light source (54) and the light detector (56) are mounted on the circuit board (52), and the circuit board (52) is mounted in the housing (44).

9. A sensor (30) as set forth in claim 1 or any other claim, where the window (40) is flat.

10. A sensor (30) as set forth in claim 1 or any other claim, where the lower cassette (42) is mounted directly to the housing (44).

11. A piston-cylinder actuator (20), comprising a piston rod (32) in a piston assembly (24) and a cylinder assembly (22), the piston rod (32) being movable relative to the cylinder assembly (22), the piston rod (32) having a pattern extending along a length of the rod (32) to identify a position along the rod (32), and an optical sensor (30) as set forth in claim 1 or any other claim mounted relative to the cylinder assembly (22) to determine the position of the rod (32) relative to the cylinder assembly (22) from a portion of the pattern detected adjacent the sensor (30).

12. An actuator (20) as set forth in claim 11 or any other claim depending from claim 11, where the lens (62) is mounted adjacent the window (40) at a distance from the surface of the piston rod (32) so as to provide a one-to-one image of an adjacent portion of the rod (32) to the light detector (56).

13. A method of making an enclosure for an optical sensor, includes the steps of molding a lower cassette from a transparent material, the lower cassette having an integral window; and connecting the lower cassette to a housing to define an enclosure for enclosing a sensor assembly therein, where the window is free of any optical distortion from the molding step.
